(19) United States
(12) Patent Application Publication
(10) Pub. No.: US 2006/0132619 A1
(43) Pub. Date: Jun. 22, 2006

(54) Image-capturing apparatus and method for correcting nonlinear images

(75) Inventors: Dong Bum Choi, Suwon-si (KR); Moon-Cheol Kim, Suwon-si (KR); Soo-Young Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/312,533

(22) Filed: Dec. 21, 2005

(30) Foreign Application Priority Data
Dec. 21, 2004 (KR) 2004-109163

(51) Int. Cl. H04N 9/73

(52) U.S. Cl. 348/224.1

(57) ABSTRACT

An image-capturing apparatus correcting nonlinear images includes an optical device for converting an input image to have nonlinear characteristics over light intensity; an image sensor for converting the input image having the nonlinear characteristics into an electric signal; a correction unit for correcting the electric signal to obtain a signal having linear characteristics over the light intensity; a converter for converting the corrected signal into a digital signal; and a signal-processing unit for processing the converted digital signal to be displayed as an output image. Thus, if the optical device having the nonlinear characteristics extends a dynamic range of the image sensor, an output having nonlinear characteristics over light intensity is corrected to have linear characteristics, so the resolution of the image can be improved.

### CROSS-REFERENCE TO RELATED APPLICATIONS

This application claims priority from Korean Patent Application No. 2004-109613 filed on Dec. 21, 2004 in the Korean Intellectual Property Office, the entire contents of which are incorporated herein by reference.

### BACKGROUND OF THE INVENTION

1. Field of the Invention

The present invention relates to image-capturing apparatus and method for correcting nonlinear images, and more particularly to image-capturing apparatus and method correcting nonlinear images in order for the images to have linear characteristics as to light intensity, wherein the image-capturing apparatus uses an image sensor having a dynamic range extended by an optical device having nonlinear characteristics.

2. Description of the Related Art

A dynamic range of an image sensor is an index indicating capability of processing light signals into images having light intensity levels. That is, the dynamic range refers to a saturation level of a pixel over a signal noise level of the pixel, and can be expressed as follows in Equation 1.

$$D = 20 {log}_{10} ( \frac{Saturation \text{-} level}{Noise} ) , \qquad [ Equation 1 ]$$

where, D denotes a dynamic range of an image sensor, “Noise” denotes signal noise, and “Saturation-level” denotes a saturation level of a pixel.

For example, if about 0.2 million electrons are detected upon saturation and about 40 electrons are detected upon noise, about 5,000 is obtained for the dynamic range, and −75 dB is obtained.

On the other hand, if one view is in mixture of dark and bright portions thereof, the time of exposure as to inputting light can be adjusted in order for all of the portions to be distinguished. However, there exist limits in distinguishing the dark and bright portions by the exposure time adjustment, so it is required to extend the dynamic range.

There exists a method of outputting saturation time, a method of using different exposure times as to respective pixels, a method of outputting an increased rate of signal charges, and so on, for the method of improving the dynamic range of an image sensor. The method of outputting a saturation time is a method of outputting an exposure time rather than of calculating pixel charges or voltages. As for an output signal of a light-receiving device, this is a method of outputting the time when the potential of a photodiode of an image sensor reaches a predetermined threshold voltage, that is, a saturation state through a counter by using a comparator instead of an analog-to-digital (A/D) converter. That is, the method decides when the potential reaches a predetermined threshold value by using a comparator rather than an A/D converter, reads a discrete amount of stored charges, and directly converts the amount into digital type signals. The method is disclosed in U.S. Pat. No. 6,069,377 and Japan Patent No. 2,953,297.

Further, the method of using different exposure times as to respective pixels has pixels exposed to strong light for short exposure times, and has pixels exposed to weak light for long exposure time, so as to maintain signal levels at the same time of obtaining a wide dynamic range. This method is disclosed in U.S. Pat. No. 6,498,576.

Further, in order to extend the dynamic range of an image sensor, from time to time, devices having nonlinear characteristics are placed prior to the image sensor in order for signals inputted to the image sensor to have nonlinear characteristics over light intensity.

Since a signal input to an image sensor having linear characteristics has nonlinear characteristics over light intensity, a signal output from the image sensor has nonlinear characteristics over light intensity. However, if a signal output from an image sensor is converted into a digital signal, there occurs a problem in that, when sampling is done about an output values of the image sensor at the same intervals, differences exist among the intervals of light intensity corresponding to the outputs at the same intervals since the signal of the image sensor has the nonlinear characteristics over the light intensity.

That is, the increased rate of the output values of the image sensor is reduced as input light intensity is increased since the output values of the image sensor has the nonlinear characteristics, so there exist differences in a change rate of the input light intensity corresponding to a change rate of the same output values. Thus, there occurs a problem of deteriorating resolution since the same outputs relatively appear over light intensity having a change rate of input light intensity.

### SUMMARY OF THE INVENTION

The present invention has been developed in order to solve the above drawbacks and other problems associated with the conventional arrangement. An aspect of the present invention is to provide image-capturing apparatus and method correcting nonlinear images in order for the images to have linear characteristics, thereby preventing resolution degradation due to the non-linearity of the images, if an optical device having nonlinear characteristics is used to extend a dynamic range of an image sensor.

According to an aspect of the present invention, there is provided an image-capturing apparatus correcting nonlinear images, comprising an optical device for converting an input image to have nonlinear characteristics over light intensity; an image sensor for converting the input image having the nonlinear characteristics into an electrical signal; a correction unit for correcting the electrical signal to obtain a signal having linear characteristics over the light intensity; a converter for converting the corrected signal into a digital signal; and a signal-processing unit for processing the converted digital signal to be displayed as an output image.

The correction unit may correct the electrical signal by using an inverse function to a nonlinear characteristic function of the optical device in order to obtain a signal having linear characteristics over the light intensity.

The correction unit may be an analog circuit having an inverse function to the nonlinear characteristic function of the optical device.

The optical device converts the electrical signal of the image sensor to have nonlinear characteristics over light intensity in a range of over predetermined light intensities, and extends a dynamic range of the image sensor through the conversion.

If the optical device does not exist, the converter has the number of bits increased in proportion to the extended dynamic range of the image sensor by the optical device, with reference to the number of bits of the converter.

The image sensor may be a charge coupled device (CCD) or a complementary metal oxide semiconductor (CMOS).

According to an aspect of the present invention, there is provided an image-capturing apparatus correcting nonlinear images, comprising an optical device for converting an input image to have nonlinear characteristics over light intensity; an image sensor for converting the input image having the nonlinear characteristics into an electrical signal; a converter for converting the electrical signal into a digital signal; a correction unit for correcting the converted digital signal to have linear characteristics over light intensity; a signal-processing unit for processing the corrected signal to be displayed as an output image.

The correction unit may correct the electrical signal to have linear characteristics over light intensity by using an inverse function to a nonlinear characteristic function of the optical device.

The correction unit may be a digital signal processor for processing the digital signal converted by the converter to have nonlinear characteristics.

The optical device may convert the electrical signal of the image sensor to have nonlinear characteristics over light intensity in a range of over predetermined light intensities, and extends a dynamic range of the image sensor through the conversion.

The image sensor may be a charge coupled device (CCD) or a complementary metal oxide semiconductor (CMOS).

According to an aspect of the present invention, there is provided a nonlinear image-correcting method for an image-capturing apparatus including an optical device having nonlinear characteristics and an image sensor for photoelectrically converting an input image having the nonlinear characteristics, comprising converting the input image to have nonlinear characteristics over light intensity so as to extend a dynamic range of the image sensor; converting the input image having nonlinear characteristics into an electrical signal; correcting the electrical signal to have linear characteristics over light intensity; converting the corrected signal into a digital signal; and processing the converted digital signal to be displayed as an output image.

The electrical signal may be corrected have linear characteristics over light intensity by using an inverse function to the nonlinear characteristic function of the optical device.

The electrical signal may be corrected by using an analog circuit having an inverse function to the nonlinear characteristic function of the optical device.

According to an aspect of the present invention, there is provided a nonlinear image-correcting method for an image-capturing apparatus including an optical device having nonlinear characteristics and an image sensor for photoelectrically converting an input image having nonlinear characteristics, the method comprising converting the input image to have nonlinear characteristics over light intensity so as to extend a dynamic range of the image sensor; converting the input image having the nonlinear characteristics into an electrical signal; converting the electrical signal to a digital signal; correcting the converted digital signal to have linear characteristics over light intensity; and processing the corrected digital signal to be displayed as an output image.

The converted digital signal is corrected to have linear characteristics over light intensity by using an inverse function to the nonlinear characteristic function of the optical device.

### BRIEF DESCRIPTION OF THE DRAWINGS

The above and/or other aspects of the present invention will be more apparent by describing certain exemplary embodiments of the present invention with reference to the accompanying drawings, in which:

FIG. 1A and FIG. 1B are block diagrams for showing schematically an image-capturing apparatus correcting nonlinear images according to an exemplary embodiment of the present invention;

FIG. 2 is a view for showing a dynamic range of an image sensor extended by the optical device of FIG. 1A or FIG. 1B;

FIG. 3A is a view for explaining a function used upon corrections of the correction unit of FIG. 1A or FIG. 1B;

FIG. 3B and FIG. 3C are views for explaining operations of the correction unit in the image-capturing apparatus of FIG. 1A and FIG. 1B, respectively; and

FIG. 4 is a flow chart for explaining a method for correcting nonlinear images according to an exemplary embodiment of the present invention.

### DETAILED DESCRIPTION OF THE EXEMPLARY EMBODIMENTS

Hereinafter, the present invention will be described in detail with reference to the accompanying drawings.

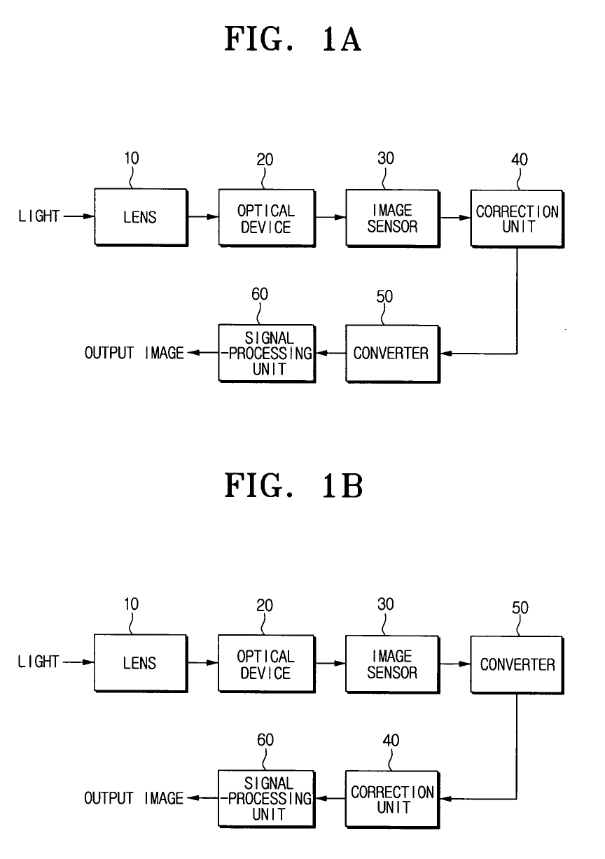

FIG. 1A and FIG. 1B are block diagrams for schematically showing an image-capturing apparatus correcting nonlinear images according to an exemplary embodiment of the present invention. FIG. 1A is a block diagram for correcting nonlinear images prior to converting an electrical signal converted in an image sensor 30 into a digital signal, and FIG. 1B is a block diagram for correcting nonlinear images after converting an electrical signal converted in the image sensor 30 into a digital signal.

In FIG. 1A and FIG. 1B, the image-capturing apparatus correcting nonlinear images includes a lens 10, an optical device 20, an image sensor 30, a correction unit 40, a converter 50, and a signal-processing unit 60.

First, the lens 10 collects and sends input light to the optical device 20.

The optical device 20 is a device having nonlinear characteristics, which enables the image sensor 30 inputting an output of the optical device 20 to output images having nonlinear characteristics over light intensity. The optical device 20 outputs images having nonlinear characteristics over light intensity, so as to extend a range of input light intensity saturating the output values of the image sensor 30.

The image sensor 30 has nonlinear characteristics over light intensity, so as to output images having more than certain light intensity as images having the same brightness. However, the optical device 20 causes the output values of the image sensor 30 to have nonlinear characteristics and also to have different output values over light intensity more than a certain light intensity, thereby extending a range of input light intensity saturating the output values. That is, the optical device 20 extends a dynamic range of the image sensor 30.

The image sensor 30 converts into an electrical signal the images input from the optical device 20. That is, the image sensor 30 detects as an analog voltage signal charges generated in proportion to the intensities of light input to the image sensor 30.

In here, the image sensor 30 can be a charge-coupled device (CCD)-type image sensor directly moving to an output unit the electrons generated by input light by using gate pulses, a CMOS-type image sensor outputting the electrons generated by input light through plural CMOS switches after conversions of the electrons into voltages of pixels, and so on.

Further, the image sensor 30 is a device having linear characteristics and the images input from the optical device 20 have nonlinear characteristics over light intensity, so an output signal of the image sensor 30 having nonlinear characteristics over light intensity as well.

The correction unit 40 corrects an image having nonlinear characteristics about light intensity into a signal having linear characteristics. In here, the correction unit 40 operates before or after the image of the image sensor 30 having nonlinear characteristics over light intensity is converted into a digital signal. That is, the correction unit 40 is placed before or after the converter 50, corrects an analog signal output from the image sensor 30, or corrects a digital signal output from the converter 50.

If the correction unit 40 operates before an image having nonlinear characteristics is converted into a digital signal, the correction unit 40 is built with analog circuit having inverse relations to a nonlinear characteristic function of the optical device 20, thereby performing the linearity of a signal input from the image sensor 30. However, if the correction unit 40 operates after an image having nonlinear characteristics is converted into a digital signal, the correction unit 40 processes a digital signal output from the converter 50 to form a nonlinear signal linear.

Further, the correction unit 40 uses the inverse relations to the nonlinear characteristic function of the optical device 20 used to output a nonlinear signal over light intensity, so as to correct an input signal to have linear characteristics over light intensity.

That is, if the optical device 20 is used to extend a dynamic range of the image sensor 30, a signal having nonlinear characteristics is output due to the nonlinear characteristic function of the optical device 20. Thus, a signal input to the image sensor 30 has nonlinear characteristics due to the nonlinear characteristic function of the optical device 20, and, if the inverse relations to the nonlinear characteristic function of the optical device 20 is applied to a signal output from the image sensor 30, the correction unit 40 can correct the signal having nonlinear characteristics into a signal having linear characteristics.

The converter 50 converts an input analog signal into a digital signal. If the correction unit 40 operates before an image having nonlinear characteristics is converted into a digital signal, the converter 50 converts into a digital signal a signal which is a signal having linear characteristics that has been corrected by the correction unit 40. However, if the correction unit 40 operates after an image having nonlinear characteristics is converted into a digital signal, the converter 50 converts into a digital signal a signal output from the image sensor 30, and outputs the converted digital signal to the correction unit 40 for corrections into a linear signal.

The signal-processing unit 60 performs signal processing so that the digital signal corrected to have linear characteristics is displayed as an output image.

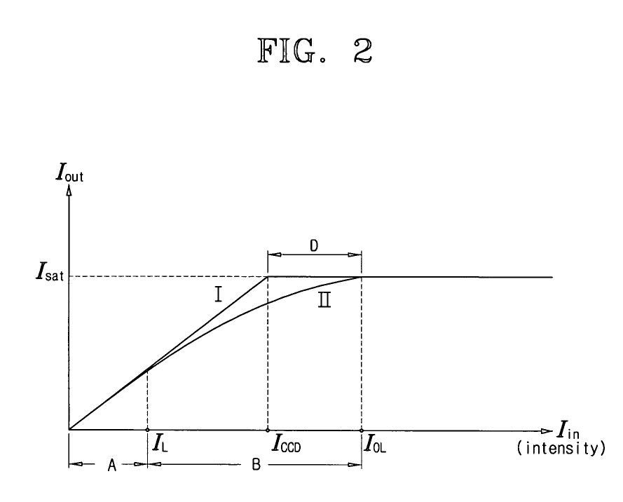

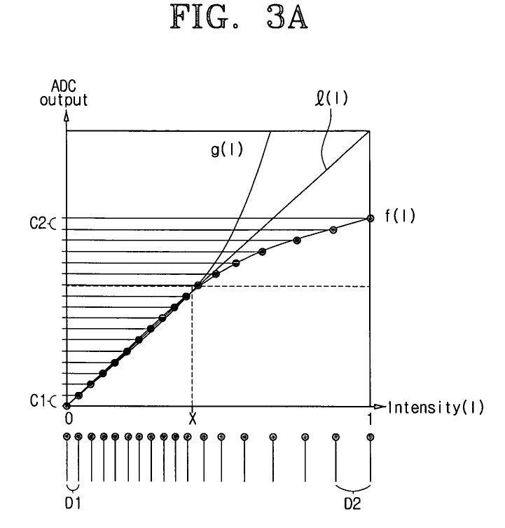

FIG. 2 is a view for showing a dynamic range of the image sensor 30 extended by the optical device 20 of FIG. 1A or FIG. 1B. In FIG. 2, the horizontal axis of indicates input light intensity, and the vertical axis indicates output values of the image sensor 30. Further, a graph I represents an output of the image sensor 30 when the image sensor 30 and the optical device 20 are not used, and graph II represents an output of the image sensor 30 when the image sensor 30 and the optical device 20 are used.

In here, reference numerals I_{CCD} and I_{OL} of the graphs I and II denote light intensity having a saturated output value, respectively, and a reference numeral Iₛₐₜ denotes a saturated output value of the image sensor 30. Further, a section A is an interval in which the output values of the graph I have liner characteristics over light intensity, and a section B is an interval in which the output values of the graph II have nonlinear characteristics over light intensity. A section D denotes an interval in which a dynamic range of the image sensor 30 is extended when the optical device 20 is used so that the output values of the image sensor 30 have nonlinear characteristics over light intensity.

In FIG. 2, when the optical device 20 is used, the graph II shows the output values of the image sensor 30 which have nonlinear characteristics over light intensity. In here, the output values of the image sensor 30 having nonlinear characteristics over light intensity appear over certain light intensity I_{L}. In the section A, that is, below I_{L}, the output values of the image sensor 30 have linear characteristics over light intensity as in the case the optical device 20 is not used.

Further, in the section B, that is, over I_{L}, the output values of the image sensor 30 have nonlinear characteristics over light intensity unlike the case the optical device 20 is not used. In the nonlinear-characteristics sections, the increase rate of the output values is reduced as light intensity in increased, compared to the linear-characteristics sections.

Since the increase amount of the output values is reduced in the section B as light intensity is increased, the output values of the image sensor 30 are different in the section D as light intensity is increased, unlike the case the optical device 20 is not used. Thus, the brightness of images can be displayed different over the light intensity of the section D. That is, a dynamic range of the image sensor 30 is extended that is an index indicating that the image sensor 30 can process light signals into images having light intensity levels.

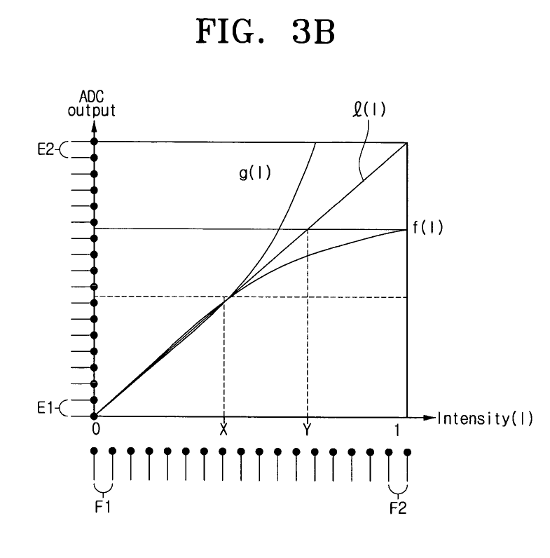

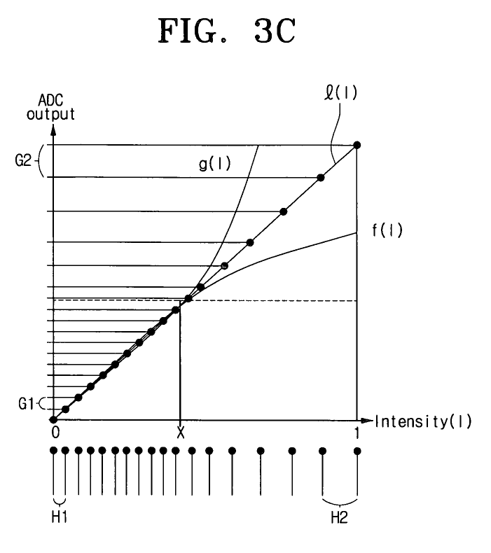

FIG. 3A is a view for explaining a function used upon corrections of the correction unit 40 of FIG. 1A or FIG. 1B. In here, reference numerals D1 and D2 denote ranges of input light intensities that can be distinguished depending on resolution, respectively, and C1 and C2 denote ranges of output values of the image sensor 30 to which sampling has been applied, at the same interval. Further, a reference numeral X denotes a maximum value of the output values having linear characteristics over light intensity, and the output values of the image sensor 30 shows linear characteristics in a range of light intensity from 0 to X.

Further, f(I) refers to a nonlinear characteristic function of the optical device 20, g(I) refers to a inverse function to a nonlinear characteristic function of the optical device 20, and l(I) refers to an output value of the converter 50 having linear characteristics over light intensity after the inverse function g(I) to the nonlinear characteristic function f(I) is applied to the nonlinear characteristic function f(I).

In FIG. 3A, if the optical device 20 is used so that the output values of the image sensor 30 have nonlinear characteristics over light intensity, a change amount of input light intensity that can be distinguished depending on resolution may be different, with respect to a change amount of the same output values of the image sensor 30.

That is, even though the change amount of input light intensity increases as the light intensity increases, the change amount of the output values of the image sensor 30 remain the same due to the nonlinear characteristics of the output values of the image sensor 30, so the same output values are detected over a relatively large change amount of the input light intensity. When the wrong output values of the image sensor 30 are used for signal processing, the resolution of output images can be deteriorated.

For example, first, it is assumed that a change amount C1 of the output values of the image sensor 30 is ‘1’ when a difference D1 of input light intensities is ½ⁿ in a range of low light intensity. In FIG. 3A, even though the change amount (C2) of the output values of the image sensor 30 becomes ‘5’ when the difference D2 of input light intensities is 5/2ⁿ in a range of high light intensity, the change amount of the output values remains ‘1’ which is the same as the difference D1 is ½ⁿ, which causes a problem.

That is, sampling is applied in the same intervals for the change amount of the output values of the image sensor 30 in the ranges of low and high light intensities, but the actual change amounts of input light intensity are different. This occurs since the output values of the image sensor 30 have nonlinear characteristics over light intensity and the increase rate of the output values decreases at the range over a certain light intensity.

In order for the output values of the image sensor 30 to be corrected to have linear characteristics over light intensity, an inverse function to a characteristic function of the optical device 20 becomes a function to be applied to the output values of the image sensor 30 having nonlinear characteristics, which can be explained in Equations 2 and 3 as follows.
I=g(f(I))=ƒ⁻¹(f(I)) [Equation 2]
g(I)=ƒ⁻¹(I) [Equation 3]
where, I denotes light intensity, and f(I) denotes a nonlinear characteristic function of the optical device 20. Further, g(I) denotes a function used to correct the output values of the image sensor 30, that is, an inverse function to the nonlinear characteristic function of the optical device 20.

In order for the output values of the image sensor 30 to be corrected to have linear characteristics, the values obtained from applying an arbitrary function to the output values of the image sensor 30 to which a nonlinear characteristic function is applied have linear characteristics. That is, in Equation 2, the input light intensity I becomes values obtained from applying an arbitrary function to the output values of the image sensor 30 to which a nonlinear characteristic function is applied.

Thus, in order for the output values of the image sensor 30 to have the linear characteristics, as expressed in Equation 3, a function applied to the output values of the image sensor 30 to which a nonlinear characteristic function is applied becomes an inverse function to the nonlinear characteristic function of the optical device 20.

FIG. 3B and FIG. 3C are views for explaining operations of the correction unit 40 of the image-capturing apparatus of FIG. 1A and FIG. 1B, respectively. That is, FIG. 3B shows that the correction unit 40 operates before images having nonlinear characteristics are converted into a digital signal, and FIG. 3C shows that the correction unit 40 operates after images having nonlinear characteristics are converted into a digital signal.

As in FIG. 3A, F1, F2, H1, and H2 denote a range of input light intensity that can be distinguished depending on resolution, respectively, and E1, E2, G1, and G2 denote a range of output values of the image sensor 30 sampled at the same interval, respectively. Further, X denotes a maximum value of the output values having linear characteristics over light intensity, and, if light intensity is in the range from 0 to X, the output values of the image sensor 30 have linear characteristics. Y denotes light intensity when the output values of the image sensor 30 have saturated output values.

In FIGS. 3B and 3C, f(I) denotes a nonlinear characteristic function of the optical device 20, and g(I) is an inverse function to the nonlinear characteristic function of the optical device 20. l(I) denotes output values of the converter 50 having linear characteristics over light intensity after the inverse function g(I) to a nonlinear characteristic function is applied to the nonlinear characteristic function f(I).

In FIG. 3B, if the correction unit 40 operates before images having nonlinear characteristics are converted into a digital signal, the output values of the correction unit 40 are obtained after corrected to have linear characteristics. Thus, input light intensity corresponding to change amounts of respective output values of the image sensor 30 that are sampled at the same interval has the same change amount. That is, a sampling rate in a range of low light intensity is identical to a sampling rate in a range of high light intensity. The correction unit 40 is built with analog circuit having inverse relations to the nonlinear characteristic function of the optical device 20.

However, if the correction unit 40 operates after images having nonlinear characteristics are converted into a digital signal, the output values of the image sensor 30 having an extended dynamic range are corrected to have linear characteristics and input to the converter 50, so the number of bits for the converter 50 has to be increased in proportion to the extension of the dynamic range of the image sensor 30. For example, when sampling is applied to the output values of the image sensor 30 not extended in the dynamic range through a eight-bit converter 50 and the dynamic range of the image sensor 30 twice increases by the optical device 20, the output values of the image sensor 30 become linear, so a 9-bit signal is generated, which requires a nine-bit converter 50.

In FIG. 3C, if the correction unit 40 operates after images having nonlinear characteristics are converted into a digital signal, the output values of the correction unit 40 appear before corrected to have linear characteristics by the correction unit 40. Thus, the output values of the converter 50 are corrected to have linear characteristics over light intensity.

In order for the output values of the converter 50 to be corrected to have linear relations over input light intensity, the change amount of the output values of the converter 50 becomes gradually increased as the change amount of light intensity gradually increases instead of the same intervals as shown in FIG. 3B. That is, a sampling rate in a low light intensity range is different from that in a high light intensity range. Thus, the resolution in the low light intensity is relatively high compared to the resolution in the high light intensity.

Therefore, if the correction unit 40 operates after images having nonlinear characteristics are converted into a digital signal, it becomes more sensitive to the change of the resolution as light intensity becomes lower since the resolution in the range of low light intensity is higher than the resolution in the high light intensity, and it becomes less sensitive to the change of the resolution as light intensity becomes higher, which shows characteristics similar to the visual feelings of humans.

If the correction unit 40 operates after images having nonlinear characteristics are converted into a digital signal, the correction unit 40 becomes a digital signal processor to correct a digital signal input from the converter 50.

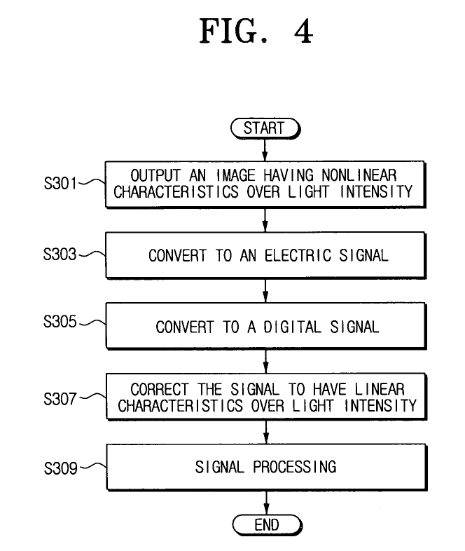

FIG. 4 is a flow chart for showing a method for correcting nonlinear characteristics according to an exemplary embodiment of the present invention.

In FIG. 4, first, the optical device 20 converts light focused by the lens 10 into an image having nonlinear characteristics over light intensity (S301). The optical device 20 is a device having nonlinear characteristics, and converts light input from the lens 10 by a nonlinear characteristic function into an image having nonlinear characteristics.

Further, as described in FIG. 2, the optical device 20 is positioned prior to the image sensor 30 in order for the image to have nonlinear characteristics over light intensity higher than a certain light intensity level, so the dynamic range of the image sensor 30 is extended. However, due to the extended dynamic range of the image sensor 30, an increase rate of the output values is reduced as light intensity over a certain level increases.

Further, the image sensor 30 converts the output image into an electrical signal to have nonlinear characteristics over light intensity (S303). That is, the image sensor 30 detects as an analog voltage the signal charges generated in proportion to input light intensity. Since the image sensor 30 is a device having linear characteristics, the image sensor 30 converts an image input to the optical device 20 and having nonlinear characteristics over light intensity into an image having nonlinear characteristics.

Next, the converter 50 converts an electrical signal, that is, an analog signal into a digital signal (S305). That is, the converter 50 is an analog-to-digital (AID) converter.

The converter 50 applies sampling to the output values of the image sensor 30 at the same interval, and outputs the same output values of the converter 50 over the change amount of light intensity corresponding to the change amount of the sampled output values of the image sensor 30. However, since the output values of the image sensor 30 have nonlinear characteristics over light intensity over a certain intensity level, the change amount of light intensity increases that corresponds to the change amount of the sampled and identical output values of the image sensor 30.

Since the output values of the image sensor 30 become identical over the large change amount of light intensity as light intensity increases, the resolution decreases as light intensity increases. Thus, in order for an image of high resolution to be displayed, the output values of the converter 50 need to be corrected to have linear characteristics over light intensity.

Next, the output values of the converter 50 are corrected to have linear characteristics over light intensity (S307). An inverse function to the nonlinear characteristic function of the optical device 20 is applied to the output values of the converter 50, so input values to the signal-processing unit 60 are corrected to have linear characteristics over light intensity. Since the output values of the converter 50 have the nonlinear characteristics due to the nonlinear characteristic function of the optical device 20, an inverse function to the nonlinear characteristic function of the optical device 20 is applied to the output values of the converter 50 so that the output values of the converter 50 have nonlinear characteristics over light intensity. The description has been made in detail on the relations between the corrected output values of the converter 50 and light intensities with reference to FIG. 3C.

Next, the corrected output values of the converter 50 are signal-processed to be displayed on a screen (S309). Since the output values of the converter 50 are corrected to have linear characteristics over light intensity, the resolution of an image can be improved that has nonlinear characteristics to extend the dynamic range of the image sensor 30.

Further, in the step S303, the output values of the image sensor 30 can be corrected to have linear characteristics for the first time, after the image sensor 30 converts an input image into an electrical signal, before converting the electrical signal into a digital signal. Next, the electrical signal corrected to have linear characteristics is converted to the digital signal, and then the digital signal is processed in order for the image to be displayed. In here, description has been made in detail on the relations between light intensity and the output values of the converter 50 converting a signal corrected to have linear characteristics into a digital signal with reference to FIG. 3B.

As aforementioned, as an optical device having nonlinear characteristics extends a dynamic range of an image sensor, the present invention corrects the outputs having nonlinear characteristics over light intensity to have linear characteristics, thereby improving the resolution of images.

The foregoing exemplary embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image-capturing apparatus comprising:
an image sensor which converts an input image having nonlinear characteristics into an electrical signal;
a correction unit which corrects the electrical signal to generate a corrected signal having linear characteristics over light intensity;
a converter which converts the corrected signal into a digital signal; and
a signal-processing unit which processes the digital signal to be displayed as an output image.

2. The image-capturing apparatus as claimed in claim 1, further comprising an optical device which converts input light to the input image having the nonlinear characteristics over the light intensity.

3. The image-capturing apparatus as claimed in claim 2, wherein the correction unit corrects the electrical signal using a function inverse to a nonlinear characteristic function of the optical device in order to generate the corrected signal having the linear characteristics over the light intensity.

4. The image-capturing apparatus as claimed in claim 2, wherein the correction unit comprises an analog circuit having a function inverse to a nonlinear characteristic function of the optical device.

5. The image-capturing apparatus as claimed in claim 2, wherein the optical device converts the input light to the image having the nonlinear characteristics over the light intensity in a range of predetermined light intensities, and extends a dynamic range of the image sensor through the conversion.

6. The image-capturing apparatus as claimed in claim 2, wherein the image sensor comprises a charge coupled device or a complementary metal oxide semiconductor.

7. The image-capturing apparatus as claimed in claim 1, wherein the converter has a number of bits which is increased in proportion to an extended dynamic range of the image sensor by the optical device.

8. An image-capturing apparatus comprising:
an optical device which converts input light to an image having nonlinear characteristics over light intensity;
an image sensor which converts the image having the nonlinear characteristics into an electrical signal;
a converter which coverts the electrical signal into a digital signal;
a correction unit which corrects the digital signal to generate a corrected signal having linear characteristics over the light intensity;
a signal-processing unit which processes the corrected signal to be displayed as an output image.

9. The image-capturing apparatus as claimed in claim 8, wherein the correction unit corrects the electrical signal to generate the corrected signal having the linear characteristics over the light intensity using a function inverse to a nonlinear characteristic function of the optical device.

10. The image-capturing apparatus as claimed in claim 8, wherein the correction unit comprises a digital signal processor which processes the digital signal having the nonlinear characteristics.

11. The image-capturing apparatus as claimed in claim 8, wherein the optical device converts the input light to the image having the nonlinear characteristics over the light intensity in a range of predetermined light intensities, and extends a dynamic range of the image sensor through the conversion.

12. The image-capturing apparatus as claimed in claim 8, wherein the image sensor comprises a charge coupled device or a complementary metal oxide semiconductor.

13. A nonlinear image-correcting method for an image-capturing apparatus including an optical device having nonlinear characteristics and an image sensor which photoelectrically converts an input image having the nonlinear characteristics, the method comprising:
converting input light to the input image having the nonlinear characteristics over light intensity so as to extend a dynamic range of the image sensor;
converting the input image having nonlinear characteristics into an electrical signal;
correcting the electrical signal to generate a corrected signal having linear characteristics over the light intensity;
converting the corrected signal into a digital signal; and
processing the digital signal to be displayed as an output image.

14. The nonlinear image-correcting method as claimed in claim 12, wherein the correcting corrects the electrical signal to generate the corrected signal having the linear characteristics over the light intensity by using a function inverse to a nonlinear characteristic function of the optical device.

15. The nonlinear image-correcting method as claimed in claim 11, wherein the correcting corrects the electrical signal using an analog circuit having a function inverse to a nonlinear characteristic function of the optical device.

16. A nonlinear image-correcting method for an image-capturing apparatus including an optical device having nonlinear characteristics and an image sensor which photoelectrically converts an input image having nonlinear characteristics, the method comprising:
converting input light to the input image having the nonlinear characteristics over light intensity so as to extend a dynamic range of the image sensor;
converting the input image having the nonlinear characteristics into an electrical signal;
converting the electrical signal to a digital signal;
correcting the digital signal to generate a corrected signal having linear characteristics over the light intensity; and
processing the corrected signal to be displayed as an output image.

17. The nonlinear image-correcting method as claimed in claim 16, wherein the correction corrects the digital signal to generate the corrected signal having the linear characteristics over the light intensity by using a function inverse to the nonlinear characteristic function of the optical device.
